(19) United States
(12) Patent Application Publication
(10) Pub. No.: US 2007/0188920 A1
(43) Pub. Date: Aug. 16, 2007

(54) Microinductor and fabrication method thereof

(75) Inventors: Hyung Choi, Yongin-si (KR); Wen Ding, Shanghai (CN); Yong Zhou, Shanghai (CN)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/706,260

(22) Filed: Feb. 15, 2007

(30) Foreign Application Priority Data
Feb. 16, 2006 (CN) 2006-10023896.0
Feb. 16, 2006 (CN) 2006-10023897.5
Feb. 16, 2006 (CN) 2006-10023898.X
Feb. 16, 2006 (CN) 2006-10023899.4
Nov. 27, 2006 (KR) 2006-117821

(51) Int. Cl. G11B 5/147

(52) U.S. Cl. 360/126

(57) ABSTRACT

A microinductor comprises a magnetic core and a coil which winds around the magnetic core. The magnetic core used in the microinductor is formed of FeCuNbCrSiB.

### CROSS-REFERENCE TO RELATED APPLICATIONS

This application claims priority under 35 U.S.C. § 119 from Chinese Patent Application No. 200610023896.0, filed Feb. 16, 2006, Chinese Patent Application No. 200610023897.5, filed Feb. 16, 2006, Chinese Patent Application No. 200610023898.x, filed Feb. 16, 2006 and Chinese Patent Application No. 200610023899.4, filed Feb. 16, 2006, in the Chinese State of Intellectual Property Office (SIPO), and Korean Patent Application No. 10-2006-0117821, filed Nov. 27, 2006, in the Korean Intellectual Property Office, the disclosure of which is incorporated herein by reference in its entirety.

### BACKGROUND OF THE INVENTION

1. Field of the Invention

Apparatuses and methods consistent with the present invention relate to a microinductor and fabrication method thereof, and more particularly, to a microinductor including a magnetic core formed of FeCuNbCrSiB, and fabrication method of the microinductor.

2. Description of the Related Art

With advances of electronic technology, electronic devices of various types are being developed and wide spread. One of elements used in the electronic device is a magnetic element such as inductor or transformer. Recently, in accordance with miniaturization trend of the electronic products, development is under way for a magnetic element which can be fabricated in miniature size and ultra light with high operation characteristics.

Particularly, a DC-DC converter including an inductor which uses a magnetic film, is prevalently used in various products such as CDMA cellular phones, ADSL network devices, computer systems, CPUs, DVD drivers, notebook computers, digital cameras, and camcorders.

In the past, the inductor was fabricated by mechanically coiling a magnetic core. Disadvantageously, such an inductor is bulky and heavy, and is subject to a high fabrication cost and a low operating frequency band.

To address those shortcomings, a three dimensional (3D) inductor is fabricated mostly using a NiFe magnetic core fabricated with MEMS process and quasi-LIGA process.

“Fabrication of high frequency DC-DC converter using Ti/FeTaN film inductor” (C. S. Kim, IEEE TRANSACTION ON MAGNETICS, VOL. 37, No. 4, 2894-2896, July, 2001), and “Ultralow-profile micromachined power inductors with highly laminated Ni/Fe cores: application to low-megahertz DC-DC converters” (J. W. Park, IEEE TRANSACTION ON MAGNETICS, VOL. 39, No. 5, 3184-3186, September 2003), disclose examples of related art microinductors.

FIGS. 1A through 1D are graphs showing characteristics of a microinductor using a NiFe magnetic core. The graphs of FIGS. 1A through 1D show experiments using a microinductor which is fabricated as a rectangular film having magnetic cores on both sides, where coils are connected while winding around the two sides.

First, FIGS. 1A and 1B are graphs acquired under the condition that a NiFe magnetic core in the rectangular shape is length*width=3900 μm*2660 μm in size, the thickness of the NiFe magnetic core is 10 μm, the width of one side of the magnetic core is 800 μm, the width of each side is the same, the coil winds around each side 32 times, the total number of the windings is 64, the coil width is 20 μm, the coil interval is 35 μm, the coil thickness is 10˜20 μm, and polyimide in thickness of 10 μm is inserted between the coil and the magnetic core as an insulator.

FIGS. 1C and 1D are graphs acquired under the condition that the NiFe magnetic core in the rectangular shape is length*width=3940 μm*3860 μm in size, the thickness of the NiFe magnetic core is 10 μm, two sides of the four sides of the magnetic core, wound by the coils, respectively are 1400 μm in thickness, the other sides respectively are 400 μm in thickness, the coil winds around each side 40 times, the total number of the windings is 80, the coil width is 20 μm, the coil interval is 35 μm, the coil thickness is 10˜20 μm, and polyimide in thickness of 10 μm is inserted between the coil and the magnetic core as an insulator.

FIGS. 1A and 1C are plots of frequency vs. inductance, and FIGS. 1B and 1D are plots of frequency vs. quality factor (Q).

However, when using NiFe for the magnetic core, to acquire the inductance or the Q factor with a proper magnitude, the magnetic core should have the thickness above 10 μm or so. Typically, the magnetic properties of the magnetic core greatly affect the performance improvement of the microinductor. Therefore, what is demanded is development of a microinductor which can be implemented with the high performance and the miniaturization using a magnetic core of a new material having better magnetic properties than NiFe.

### SUMMARY OF THE INVENTION

An aspect of the present general inventive concept is to provide a microinductor which can be implemented in miniaturization by including a magnetic core formed of FeCuNbCrSiB, and fabrication method of the microinductor.

According to an aspect of the present invention, a microinductor comprises a magnetic core which is formed of FeCuNbCrSiB; and a coil which winds around the magnetic core.

The microinductor may further comprise an insulator which insulates the magnetic core.

In this case, the insulator may be aluminum oxide or polyimide.

The microinductor may further comprise a substrate which supports the magnetic core and the coil; and a plurality of pads which are located on the substrate and connected to the coil.

The coil may comprise a lower coil pattern which interposes between the substrate and the magnetic core; an upper coil pattern which is located on the magnetic core; and a via which connects the lower coil pattern to the upper coil pattern.

The magnetic core may be a closed magnetic circuit which has two sides facing each other on the substrate.

The coil may comprise a first coil which winds around a first side of the two sides of the magnetic core; and a second coil which winds around a second side of the two sides of the magnetic core, the second coil connected to the first coil at one end.

One end of the first coil may be connected to a first pad of the plurality of the pads, the other end of the first coil may be connected to the one end of the second coil, and the other end of the second coil may be connected to a second pad of the plurality of the pads.

A width of each winding of the coil may be 20˜40 μm, a thickness of each winding may be 5˜20 μm, and an interval between the windings may be 20˜40 μm.

The magnetic core may be a thin film type of thickness 2˜6 μm.

According to the above aspect of the present invention, a fabrication method of a microinductor which comprises a magnetic core and a coil winding around the magnetic core, comprises forming a lower coil pattern on a substrate; fabricating a magnetic core formed of FeCuNbCrSiB, in a certain pattern on the substrate where the lower coil pattern is formed; forming a via pattern connected to the lower coil pattern; and fabricating a coil to wind around the magnetic core by depositing an upper coil pattern being connected to the via pattern.

The forming the lower coil pattern may comprise forming a seed layer on a surface of the substrate and forming an alignment mark on at least one surface of the substrate; and forming the lower coil pattern by plating along the seed layer. The fabricating the magnetic core, the forming the via pattern and the fabricating the coil may be performed at a corresponding position based on the alignment mark.

For the fabricating the magnetic core, the magnetic core may be fabricated at a position apart from the lower coil by a distance, and the magnetic core may be a closed magnetic circuit which has two sides facing each other.

The fabricating the magnetic core may comprise depositing a FeCuNbCrSiB film on the substrate where the lower coil pattern is formed, by sputtering using a FeCuNbCrSiB sample; and fabricating the magnetic core by patterning the FeCuNbCrSiB film.

The forming the via pattern may comprise forming a pad together with the via pattern.

The fabrication method may further comprise annealing the microinductor in a vacuum furnace at a temperature while a magnetic field is applied.

The sputtering process may be conducted in a sputtering chamber in which the substrate having the lower coil pattern and the FeCuNbCrSiB sample are placed, under the following condition: gas in sputtering chamber: argon, pressure in sputtering chamber: 4.2 Pa, sputtering time: 1˜2 h, sputtering power: 600 W, flow rate: 13 SCCM, magnitude of magnetic field: 16 kA/m, and direction of magnetic field: parallel with the substrate surface.

### BRIEF DESCRIPTION OF THE DRAWINGS

The above and/or other aspects of the present invention will be more apparent by describing certain exemplary embodiments of the present invention with reference to the accompanying drawings, in which:

FIGS. 1A through 1D are graphs showing properties of a related art microinductor using a magnetic core formed of NiFe;

FIG. 2 is a simplified conceptual diagram of a microinductor according to an exemplary embodiment of the present invention;

FIG. 3 is a plane diagram of a microinductor according to an exemplary embodiment of the present invention;

FIG. 4 is a perspective view of the microinductor of FIG. 3;

FIG. 5 is a cross-sectional view taken along I-I of FIG. 3;

FIGS. 6, 7A, and 7B are conceptual diagrams of exemplary magnetic cores used in the microinductor of FIG. 3;

FIG. 8 is a conceptual diagram of a plurality of microinductors on a wafer according to an exemplary embodiment of the present invention;

FIGS. 9A through 9E are cross-sectional views showing a microinductor fabrication method according to an exemplary embodiment of the present invention;

FIGS. 10A through 10D are graphs showing microinductor properties according to an exemplary embodiment of the present invention;

FIGS. 11A through 11E are photos, taken by an electron microscope, of surface state of the magnetic core used in the microinductor according to an exemplary embodiment of the present invention;

FIGS. 12A through 12E are graphs of magnetic field-magnetic moment properties of the microinductor along a magnetization easy axis; and

FIGS. 13A through 13E are graphs of magnetic field-moment properties of the microinductor along a magnetization hard axis.

### DETAILED DESCRIPTION OF THE EXEMPLARY EMBODIMENTS

Certain exemplary embodiments of the present invention will be described in greater detail with reference to the accompanying drawings.

In the following description, the same drawing reference numerals are used to designate analogous elements throughout the drawings. The matters defined in the description such as a detailed construction and elements are provided to assist in an understanding of the invention. However, the present invention can be carried out in different manners. Also, well-known functions or constructions are not described in detail since they would obscure the invention in unnecessary detail.

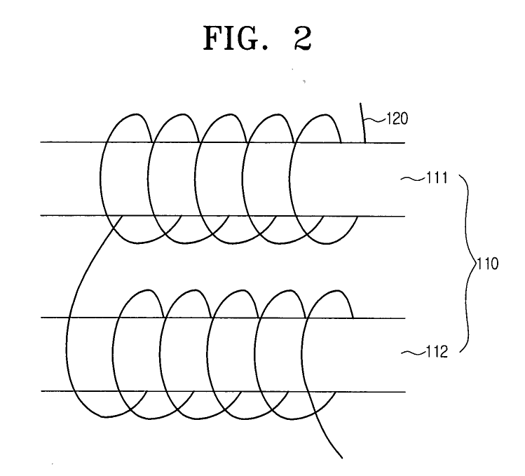

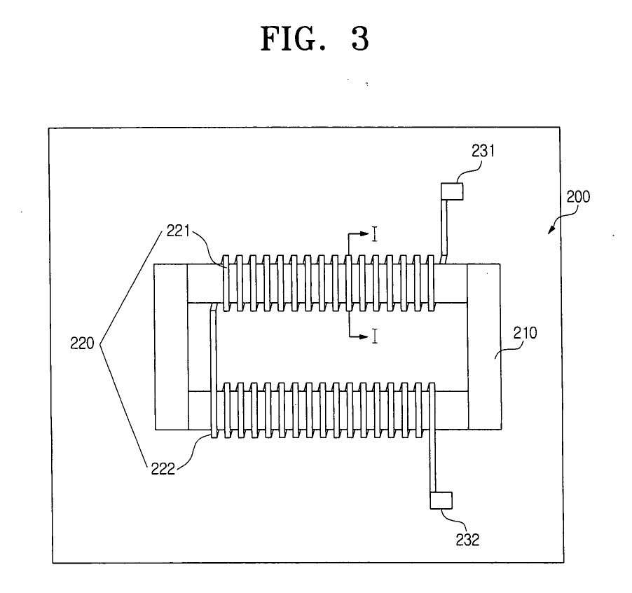

FIG. 2 is a simplified conceptual diagram of a microinductor according to an exemplary embodiment of the present invention. Referring to FIG. 2, the microinductor comprises a magnetic core 110 and a coil 120.

The magnetic core is formed of FeCuNbCrSiB. While the magnetic core 110 is in a shape of two bars 111 and 112 in FIG. 2, the magnetic core 110 can form a closed magnetic circuit such as rectangular ring having two facing sides.

The coil 120 winds around the two sides 111 and 112 of the magnetic core 110, respectively. The wound coils are connected to each other.

FIG. 3 is a plane diagram of a microinductor according to an exemplary embodiment of the present invention. The microinductor of FIG. 3 comprises a substrate 200, a magnetic core 210, a coil 220, and pads 231 and 232.

The magnetic core 210 is formed of FeCuNbCrSiB and forms a closed magnetic circuit such as rectangular shape. In the rectangular ring structure, each side is formed in a bar shape.

The coil 220 comprises a first coil 221 which winds around one of two facing sides of the magnetic core 210, and a second coil 222 which winds around the other side.

One end of the first coil 221 is connected to the first pad 231 and the other end is connected to one end of the second coil 222. The other end of the second coil 222 is connected to the second pad 232.

The first and second pads 231 and 232 serve to transfer an electric signal applied from outside, to the coil 220.

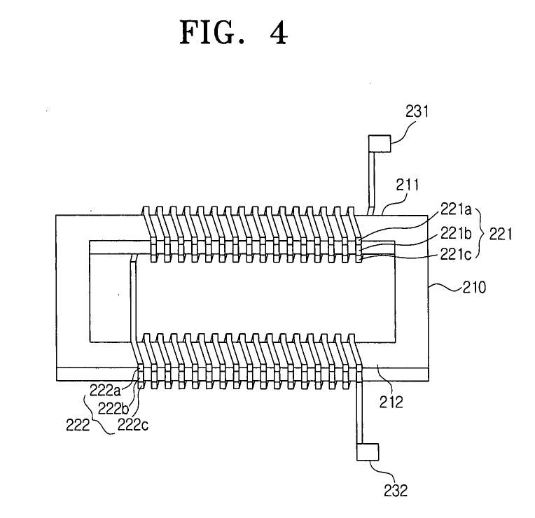

FIG. 4 is a perspective view of the microinductor of FIG. 3. Referring to FIG. 4, the first coil 221 and the second coil 222 comprise lower coil patterns 221c and 222c, vias 221b and 222b, and upper coil patterns 221a and 222a, respectively. The lower coil patterns 221c and 222c are fabricated on a surface of the substrate 200. The upper coil patterns 221a and 222a are fabricated above the magnetic core 210. The vias 221b and 222b are fabricated on both sides of the first and second sides 211 and 212 to connect the lower coil patterns 221c and 222c to the upper coil patterns 221a and 222a, respectively.

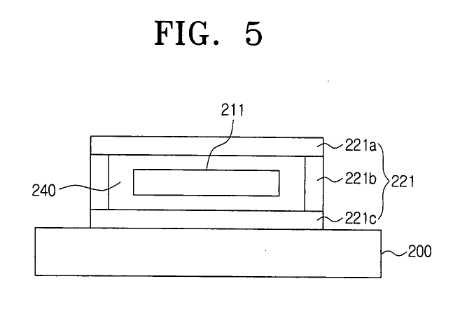

FIG. 5 is a cross-sectional view of the first side 211 of the magnetic core 210 of the microinductor, which is taken along I-I of FIG. 3. Referring to FIG. 5, an insulator 240 is interposed between the first coil 221 and the first side 211 of the magnetic core 210, to insulate the first side 211. While only the first side 211 is illustrated in FIG. 5, the second side 212 has the same structure.

The insulator 240 can use polyimide or aluminum oxide.

Note that the sizes of the magnetic core 210 and the coil 220 in the microinductor of FIGS. 3,4, and 5 can be variously designed to acquire an intended impedance.

The impedance of the microinductor is expressed as Equation 1.

$$L = \frac{{μ}_{0} {μ}_{r} {A}_{c} {N}^{2}}{{l}_{c}} \qquad [ Equation 1 ]$$

In Equation 1, L denotes inductance, μ₀ denotes absolute permeability of vacuum, μᵣ denotes relative permeability of a core material, l_{c} denotes a total length of the closed magnetic circuit core, N denotes a total number of coil windings, and A_{c} denotes a cross section of the magnetic core 210. To acquire an intended inductance based on Equation 1, l_{c}, N, and A_{c} are adjusted.

The width of each coil winding may range about 20˜40 μm, the thickness of each winding can range about 5˜20 μm, and the interval between the windings can range about 20˜40 μm. Also, the magnetic core 210 can be designed as a layer in the thickness of about 2˜6 μm. Note that the structure of the magnetic core 210 is variously changeable. To implement a miniature inductor with high inductance, the number of the windings may be increased or the cross section of the magnetic core 210 may be expanded.

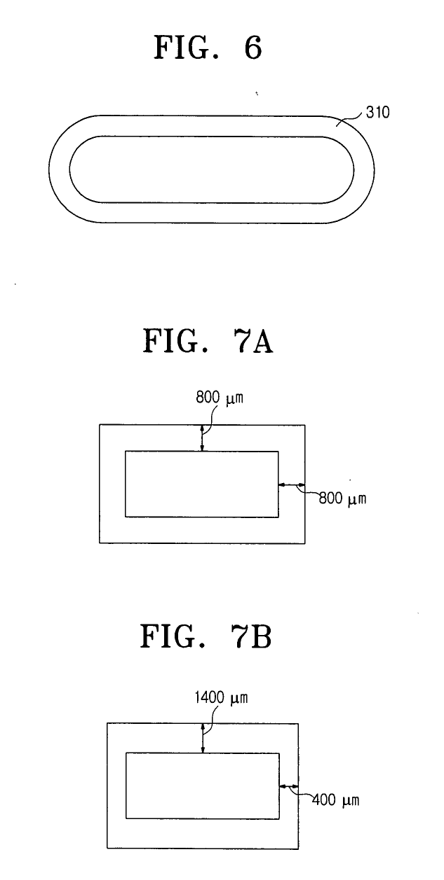

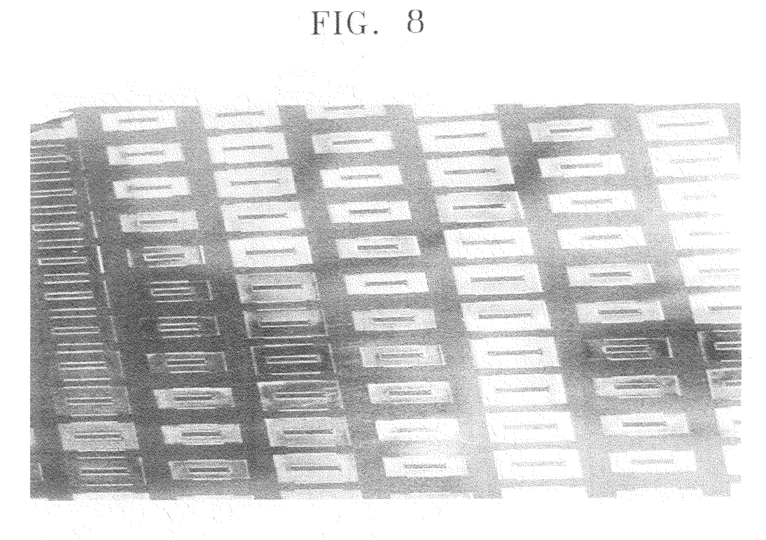

FIGS. 6, 7A, and 7B are conceptual diagrams of exemplary magnetic cores used in the microinductor of FIG. 3. FIG. 6 depicts a magnetic core of a closed magnetic circuit 310 type, which has two straight sides facing each other and the other parts excluding the straight sides are formed in a curve shape.

FIG. 7A depicts a magnetic core (hereafter, referred to as an A type) of a rectangular ring type in which the widths of four sides are the same, and FIG. 7B depicts a magnetic core (hereafter, referred to as a B type) of a rectangular ring type in which the width of two sides wound by the coil is greater than that of the other sides. In addition, the magnetic core may be fabricated in a two-bar shape as shown in FIG. 2.

FIG. 8 is a photo of a plurality of microinductors fabricated simultaneously on a wafer according to an exemplary embodiment of the present invention. Over the entire area of one wafer, the lower coil patterns 221c and 222c, the magnetic core 210, vias 221b and 222b, and the upper coil patterns 221a and 222a are fabricated at the same time so that a plurality of microinductors are fabricated simultaneously. Next, the microinductors are separated by dicing.

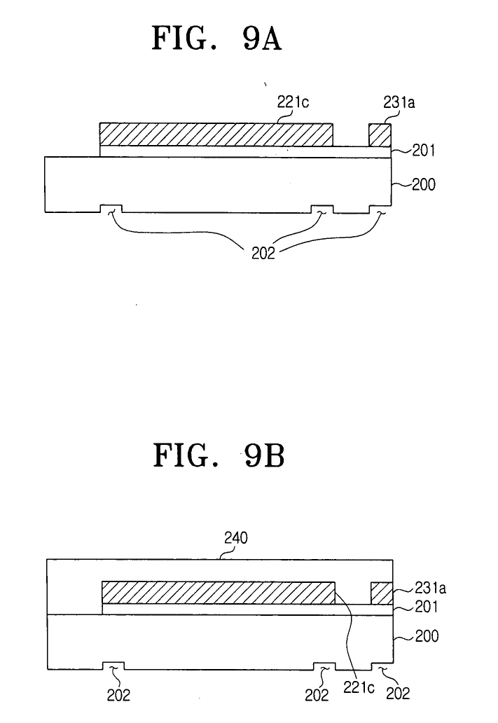

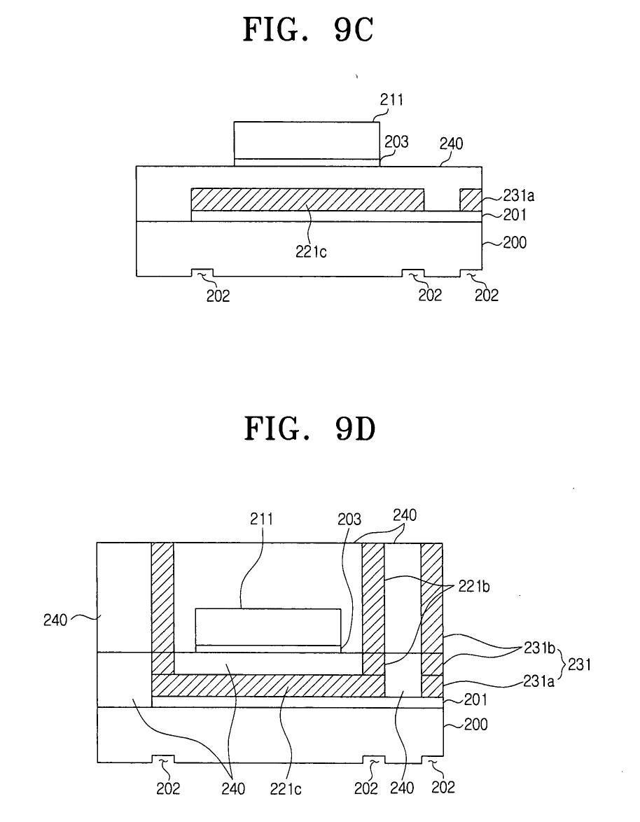

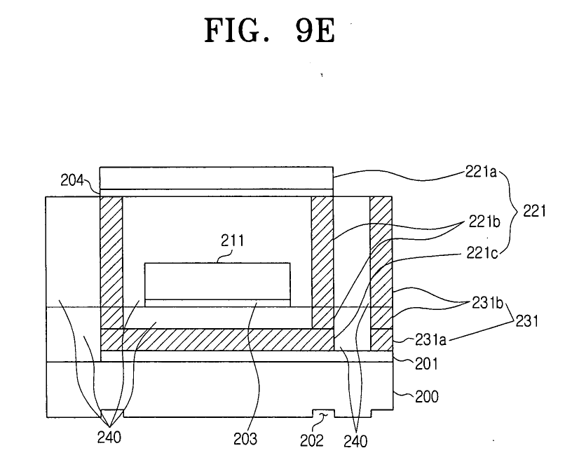

FIGS. 9A through 9E are cross-sectional views showing a microinductor fabrication method according to an exemplary embodiment of the present invention. Since FIGS. 9A through 9E are cross-sectional views of the microinductor of FIG. 3 to illustrate the fabrication of the microinductor based on a position corresponding to the first side 211, the fabrication process of the second side 212 is not shown in FIGS. 9A through 9E. However, the process on the sides 211 and 212 is the same.

Referring first to FIG. 9A, the lower coil pattern 221c and the first lower pad 231a are fabricated on the surface of the substrate 200. In more detail, by sputtering a material such as Cr or Cu, a seed layer 201 in the thickness of about 100 nm is deposited on the surface of the substrate 200. To facilitate the microinductor fabrication, an alignment mark 202 can be used. While the alignment mark is mostly fabricated on the front side of the substrate, it can be formed on the rear side to ease the fabrication.

The Cr/Cu seed layer 201 may be sputtered under the following condition.

[Seed Layer Sputtering Condition]

1. Substrate vacuum degree: 4*10⁻⁴ Pa

2. Ar pressure: 0.67 Pa

3. Sputtering electric power: 800 W

4. Ar flow rate: 20 SCCM

Upon the deposit of the seed layer 201, the lower coil pattern 221c and the first lower pad 231a are fabricated using a photoresist (not shown). More specifically, after patterning the seed layer 201, the photoresist (not shown) is spread in the thickness of about 10 μm, heated to temperature approximately of 90˜95° C. and left for 60 minutes or so, undergone exposure and development, and then plated using the seed layer 201. As a result, the lower coil pattern 221c and the first lower pad 231a are fabricated. The plating material can be Cu. Although not shown in FIG. 9A, the lower coil pattern 222c and the second lower pad 232a at the position corresponding to the second side 212 of the magnetic core 210 are fabricated at the same time.

FIG. 9B is a cross-sectional view showing a fabrication of an insulator plate between the coil and the magnetic core. The insulator can use PR or polyimide. The insulator such as aluminum oxide (Al₂O₃) can be deposited according to a sputtering method and then patterned.

The insulator can be sputtered under the following sputtering condition.

### [Insulator Sputtering Condition]

1. Substrate vacuum degree: 4*10⁻⁴ Pa

2. Ar pressure: 2.66 Pa

3. Sputtering power: 4000 W

4. Ar flow rate: 70 SCCM

Next, as shown in FIG. 9C, the magnetic core 210 is fabricated together with its one side 211. In more detail, after the Cr seed layer 203 is sputtered in the thickness of 20˜30 nm, the FeCuNbCrSiB film is sputtered in the thickness of 2˜6 μm and patterned. Therefore, the magnetic core 210 is fabricated with its one side 211.

The sputtering process is described in more detail. First, a FeCuNbCrSiB target is separately fabricated. Specifically, in a vacuum oven filled with argon gas, Fe of 99.8%, Si of 99.9%, Nb of 99.6%, Cu of 99.9%, and Cr of 99.8% are arc-melted to thus make a Fe—Cu—Nb—Cr—Si—B alloy sample of composition ratio Fe_{73.5}Cu₁Nb₂Cr₁Si_{13.5}B₉. Next, the alloy sample is cut to form a thin target in the thickness of 34 mm and the diameter of 153 mm. Hence, using the fabricated target, FeCuNbCrSiB film can be deposited through the magnetron sputtering in the SPF-312 system.

An optimum condition can be obtained by measuring the permeability and the coercivity of the magnetic layer in the respective conditions by varying the sputtering power, the flow rate, and the argon pressure.

The magnetic material can be sputtered under the following condition.

[FeCuNbCrSiB Sputtering Condition]

1. Substrate vacuum degree: 1.1*10⁻⁴ Pa

2. Ar pressure: 4.2 Pa

3. Sputtering power: 600 W

4. Ar flow rate: 13 SCCM

5. Sputtering time: 1˜2 h

6. Magnetic field: 16 kA/m

Herein, the magnetic field can be applied in parallel with the long side of the magnet core 210.

The composition ratio of the magnetic core fabricated using the sputtering method can be acquired using various methods such as inductively coupled plasma (OCP) analysis. The acquired composition ratio is about Fe_{76.2}Si_{9.2}B_{6.9}Cu_{4.8}Nb_{0.1}Cr_{1.3}Ni_{1.5}. Using the differential scanning calorimetry (DSC) curve (not shown) of the magnetic film, the Curie temperature is about 447° C. and the crystallization temperature is about 602° C.

Note that the composition ratio of the components may change when sputtering under the different sputtering condition with the sample of the different composition ratio.

As such, upon the completion of the fabrication of the magnetic core 210, as shown in FIG. 9D, the via 221b and the first pad 231 are completed. More specifically, while the magnetic core 210 is fabricated, the photoresist in the thickness of about 20 μm is deposited and the exposure process and the development process are performed. Thus, the via 221b and the first pad 231 are exposed. Next, the first upper pad 231b and the via 221b are formed through the plating. The front side is polished until it becomes flat by CMP.

Next, the upper coil pattern 221a is formed using another seed layer 204 as shown in FIG. 9E. Hence, the first coil 221 winding around the first side 211 of the magnetic core is completed. At the same time, the second coil 222 winding around the second side 212 is also completed. The detailed fabrication of the upper coil pattern 221a is the same as that of the lower coil pattern 221c, and its further explanation shall be omitted.

The completed coil may be in a solenoid shape, the width of the winding may be 20˜40 μm, its thickness may be 5˜20 μm, and the winding interval may be 20˜40 μm. The number of the coil windings differs depending on the length of the magnetic core 210.

As above, upon the completion of the core structure 220, the microinductor is put into a vacuum furnace and heated at 250° C. while applying the magnetic field for 30 minutes. Therefore, the fabrication of the microinductor is completed. The respective microinductors are separated through dicing. In doing so, unnecessary wires for the plating may be cut off.

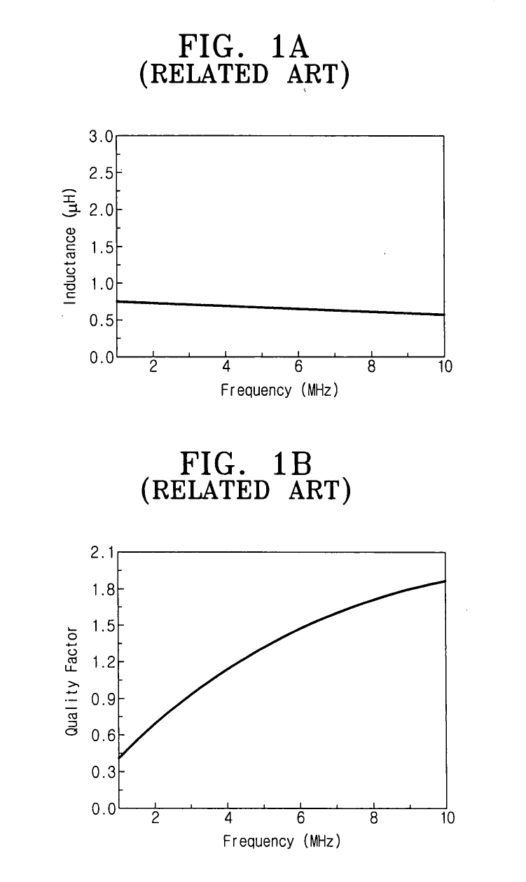

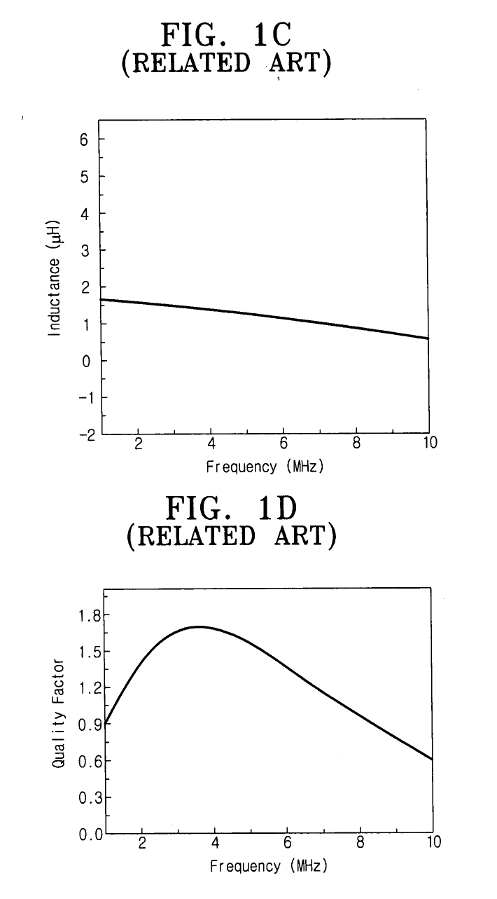

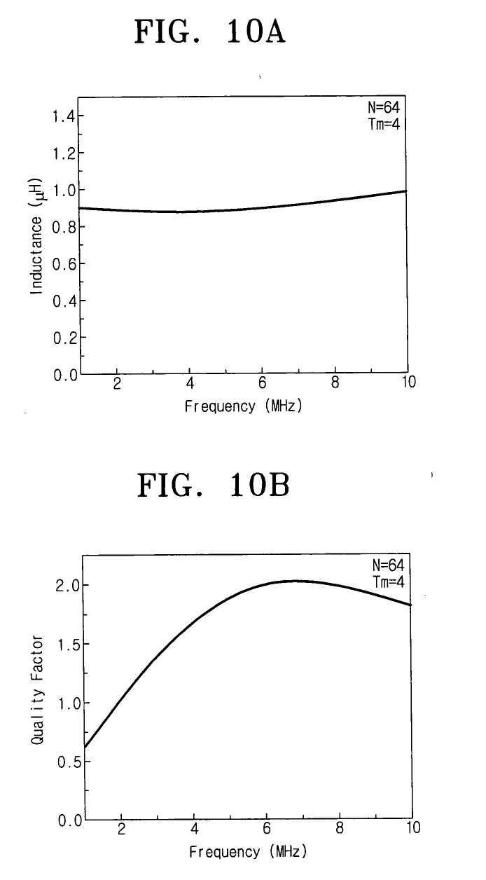

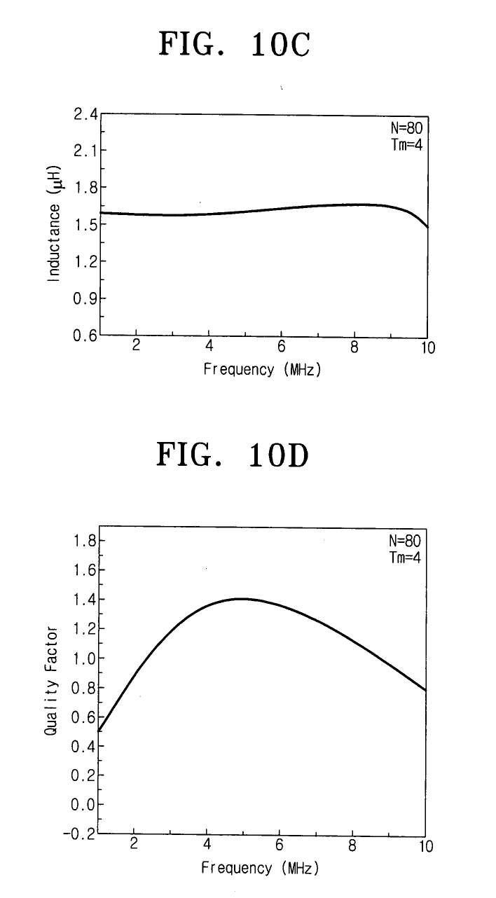

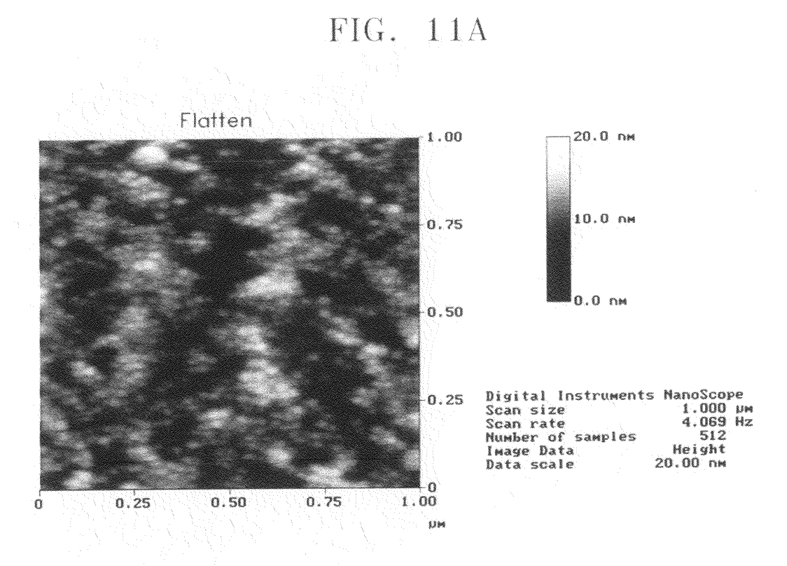

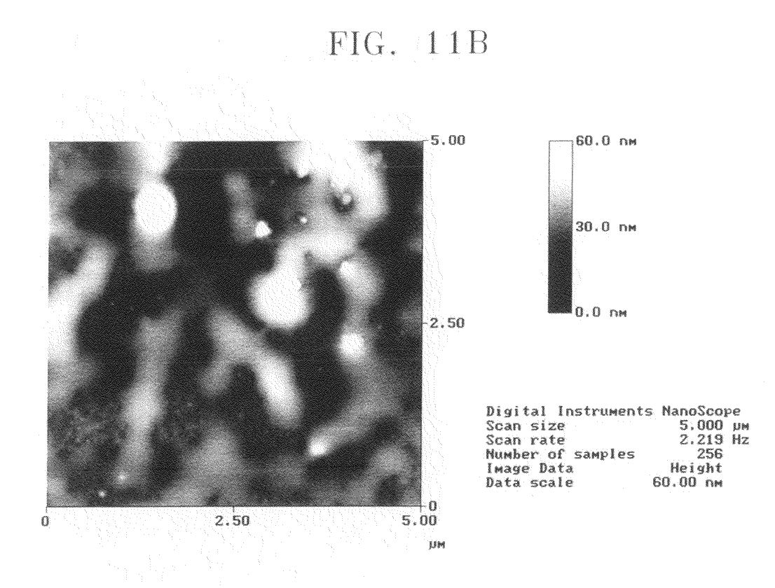

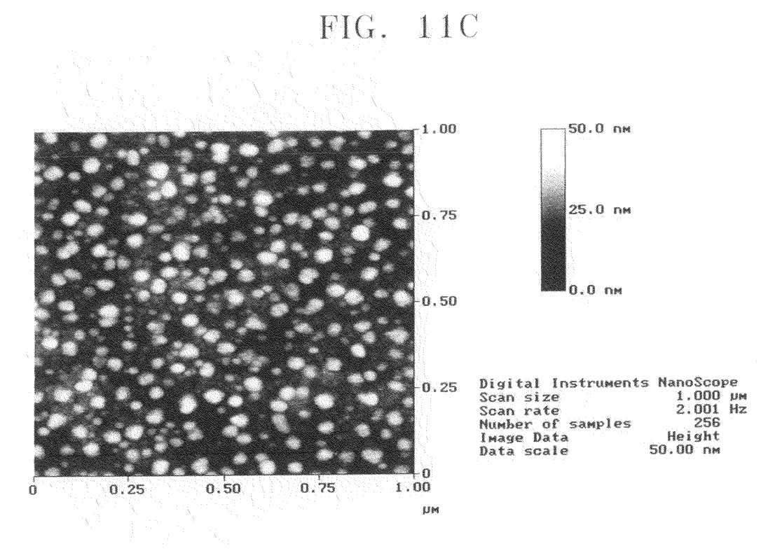

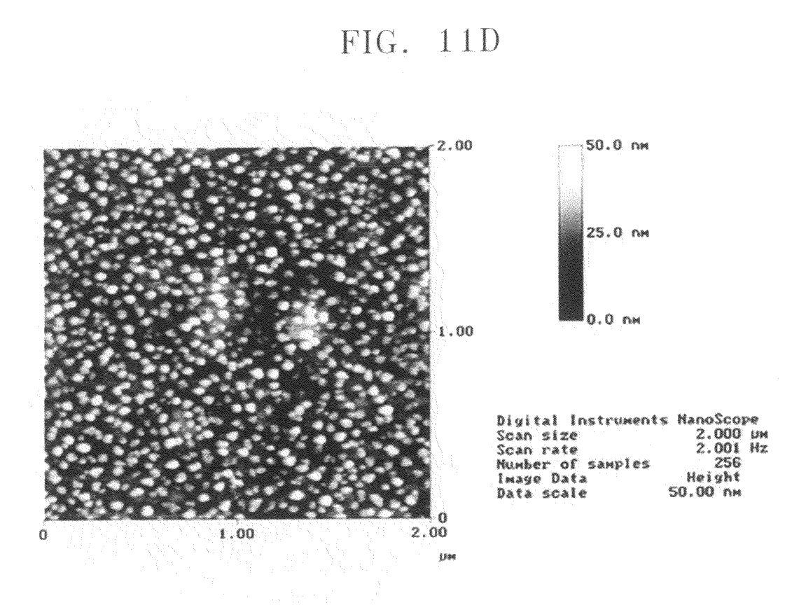

FIGS. 10A through 10D are graphs showing microinductor characteristics according to an exemplary embodiment of the present invention. FIGS. 10A through 10D show the experiment graphs using the microinductor in which the magnetic core is fabricated as a rectangular-ring type thin film having two sides and the coils winding the two sides are connected to each other. Hence, by comparing with the graphs of FIGS. 1A through 1D, the performance of the microinductor of the present invention can be compared with that of the related art microinductor.

FIGS. 10A and 10B show graphs under the condition that the rectangular-ring type FeCuNbCrSiB magnetic core is width*length=3900 μm*2660 μm in size, the thickness of the magnetic core is 3˜6 μm, the width of each side of the magnetic core is 800 μm, the coil winds around each side for 32 times, the total number of the windings is 64, the coil width is 20 μm, the coil interval is 35 μm, the coil thickness is 10˜20 mm, and the polyimide of the thickness 10 μm is inserted between the coil and the magnetic core as an insulator.

FIGS. 10C and 10D show graphs under the condition that the rectangular-ring type FeCuNbCrSiB magnetic core is width*length=3940 μm*3860 μm in size, the thickness of the FeCuNbCrSiB magnetic core is 3˜6 mm, the width of the long side of the magnetic core is 1400 μm as the B type, the coil winds around each side for 40 times, the total number of the windings is 80, the coil width is 20 μm, the coil interval is 35 μm, the coil thickness is 10˜20 μm, and the polyimide of the thickness 10 gem is inserted between the coil and the magnetic core as an insulator.

FIGS. 10A and 10C are plots of frequency vs. inductance, and FIGS. 10B and 10D are plots of frequency vs. quality factor (Q).

Comparing FIGS. 1A through 1D with FIGS. 10A through 10D, as one can see, the impedance and the Q factor properties when using the NiFe magnetic core of the thickness 10 μm is substantially similar to the impedance and the Q factor properties when using the FeCuNbCrSiB magnetic core of the thickness about 3˜6 μm. Therefore, the thickness of the magnetic core can be halved compared to the related art inductor, thereby reducing the entire size of the microinductor.

Meanwhile, annealing experiments can be conducted to examine the properties of the FeCuNbCrSiB magnetic core used in the microinductor of FIGS. 3 through 5. Specifically, the experiments are conducted on the changes of the properties after a certain time duration after heating the magnetic core samples at the temperature of 300° C., 400° C., 500° C., and 600° C., respectively, for 30 minutes.

Accordingly, to acquire the structural properties of the thin film before and after the heating, Young's modulus and hardness can be measured. The Young's modulus and the hardness are arranged at the respective heating temperatures in Table 1.

TABLE 1

| | | annealed | annealed | annealed | annealed |
|---|---|---|---|---|---|
| | | at | at | at | at |
| | as-deposited | 300° C. | 400° C. | 500° C. | 600° C. |
| Young's | 156.6 | 159 | 150 | 192 | 197.5 |
| modulus | | | | | |
| (GPa) | | | | | |
| Hardness | 12.34 | 9.4 | 8.8 | 11.4 | 11.9 |
| (GPa) | | | | | |

Besides, to acquire the surface structure and the magnetic property of the film type magnetic core, X-ray, AFM, B-H loop, and the like can be used.

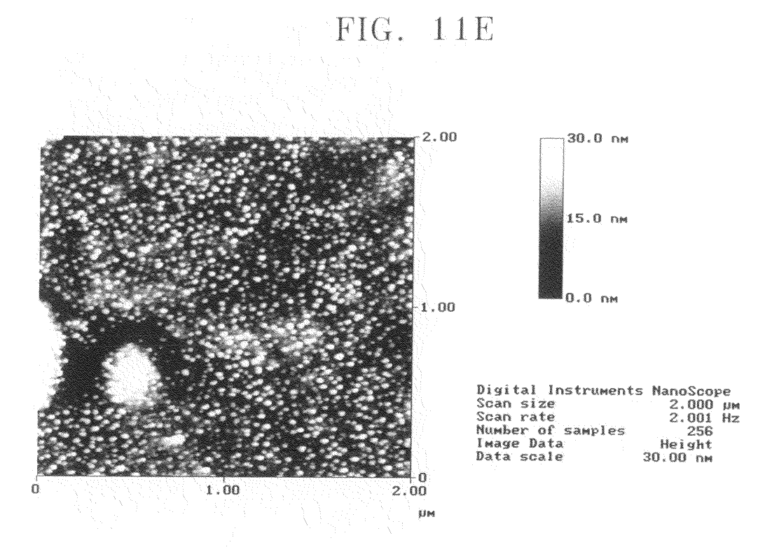

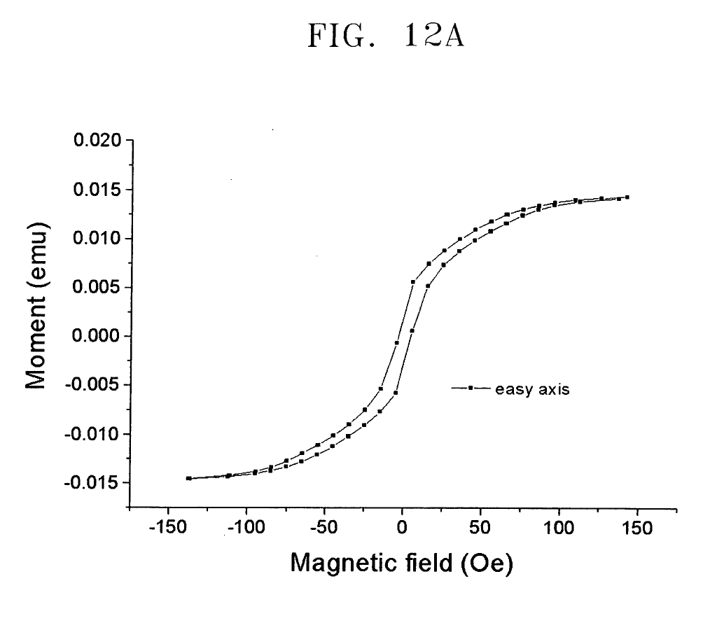

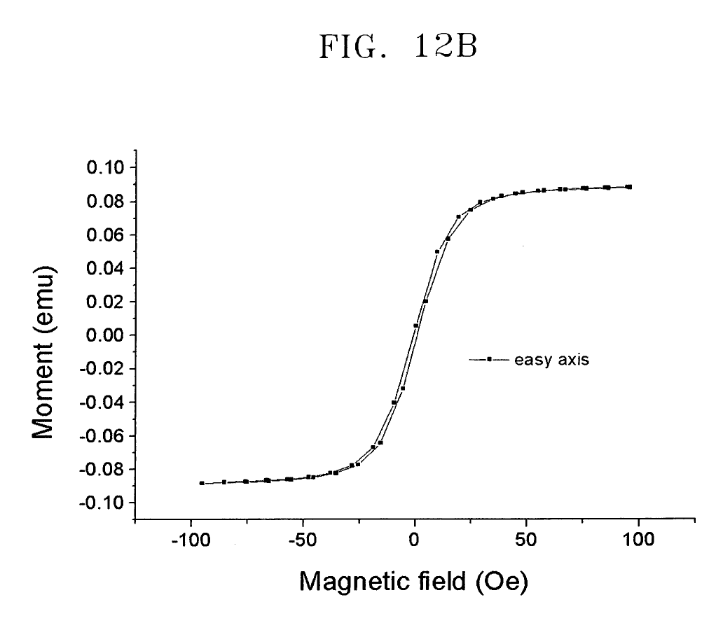

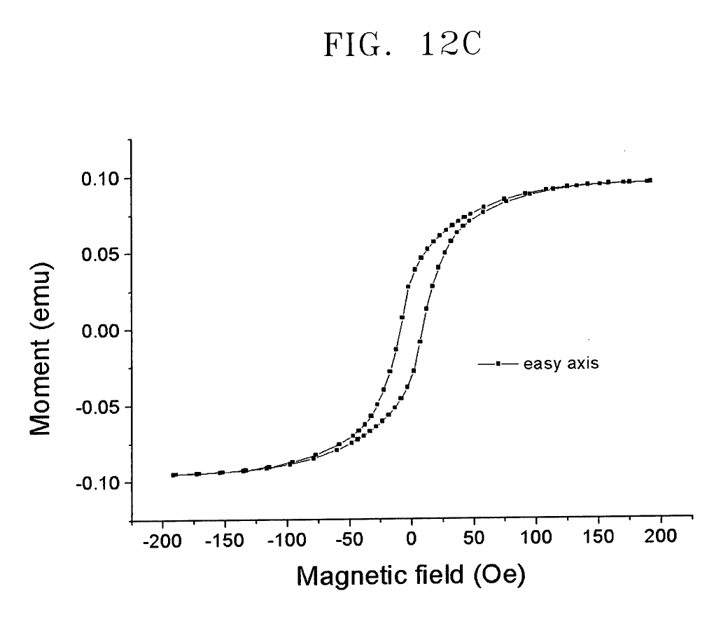

FIGS. 11A through 11E are photos taken by an electron microscope at the respective temperatures. FIG. 11A shows the surface of the magnetic core 210 deposited as it was, FIG. 11B shows the surface of the magnetic core 210 heated at 300° C., FIG. 11C shows the surface of the magnetic core 210 heated at 400° C., FIG. 11D shows the surface of the magnetic core 10 heated at 500° C., and FIG. 11E shows the surface of the magnetic core 210 heated at 600° C. As shown in FIGS. 11A through 11E, the magnetic core surface prior to the heating is amorphous and the crystallization initiates at 400° C. Above 500° C., nanometer-sized crystals are formed.

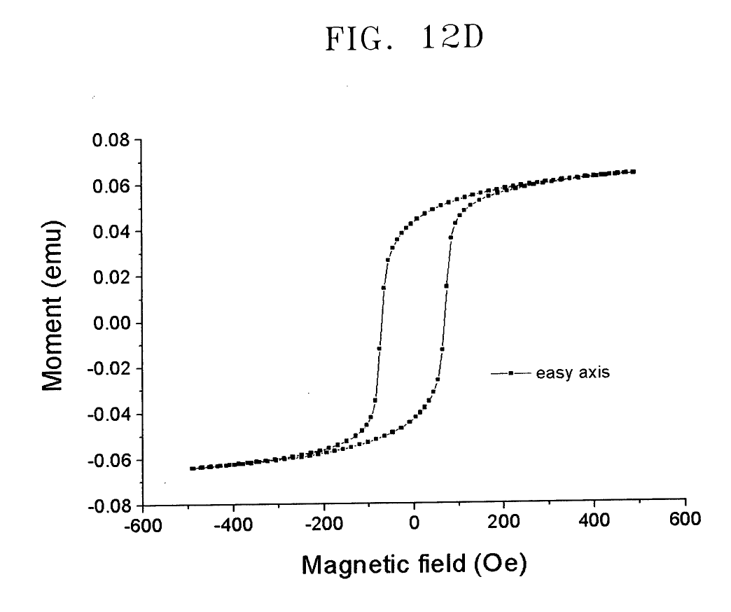

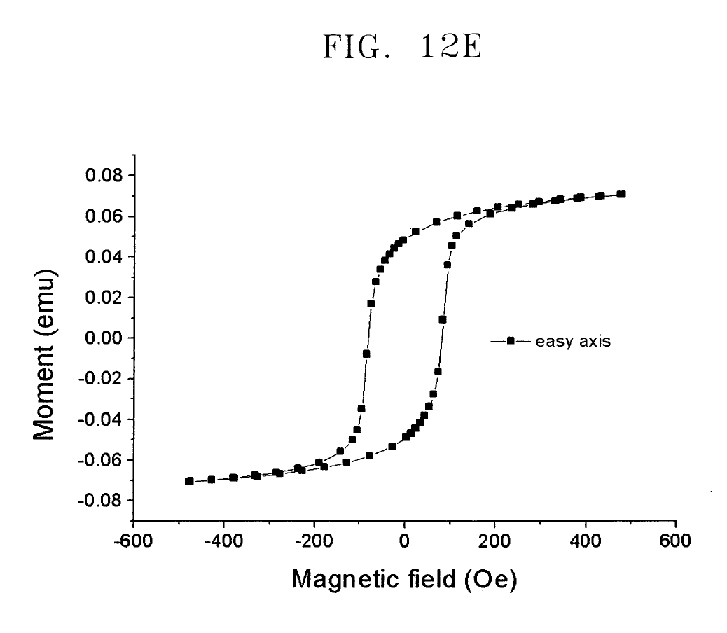

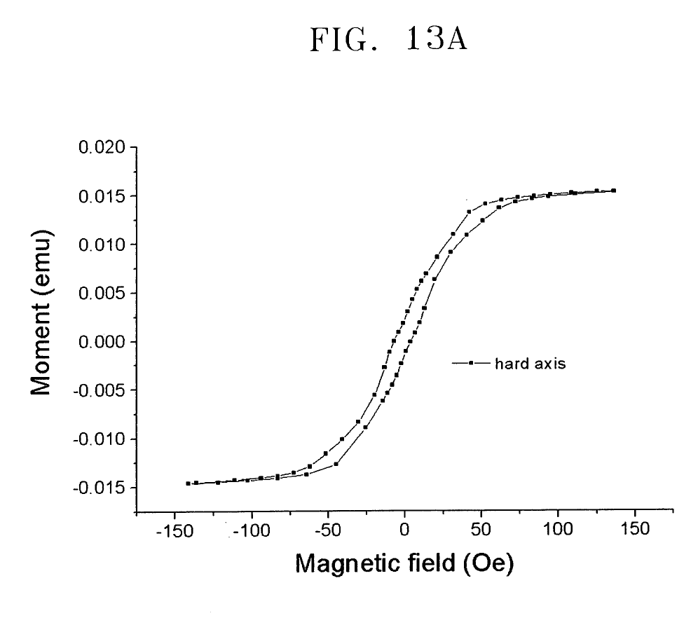

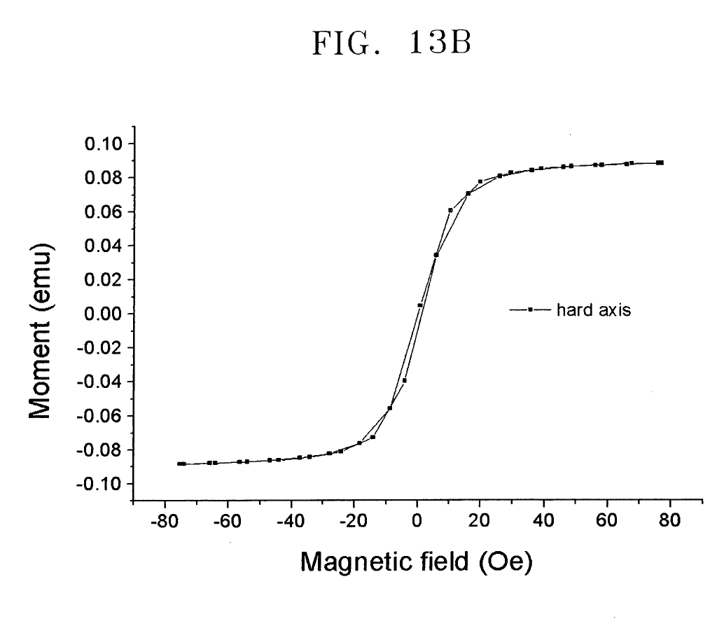

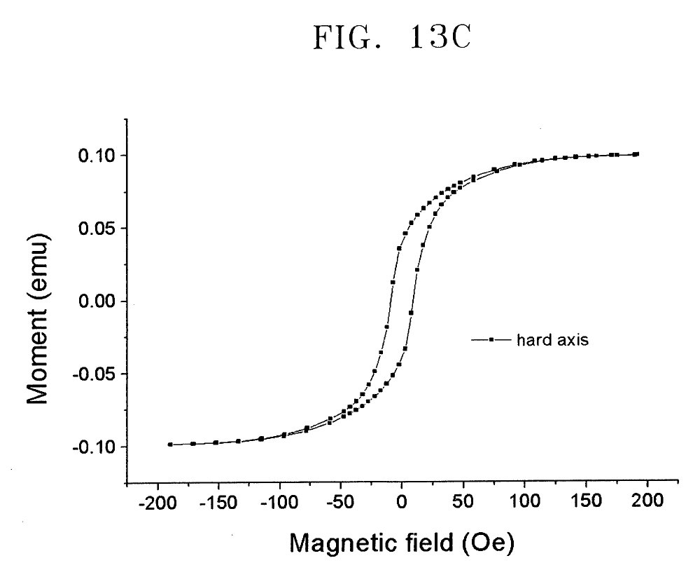

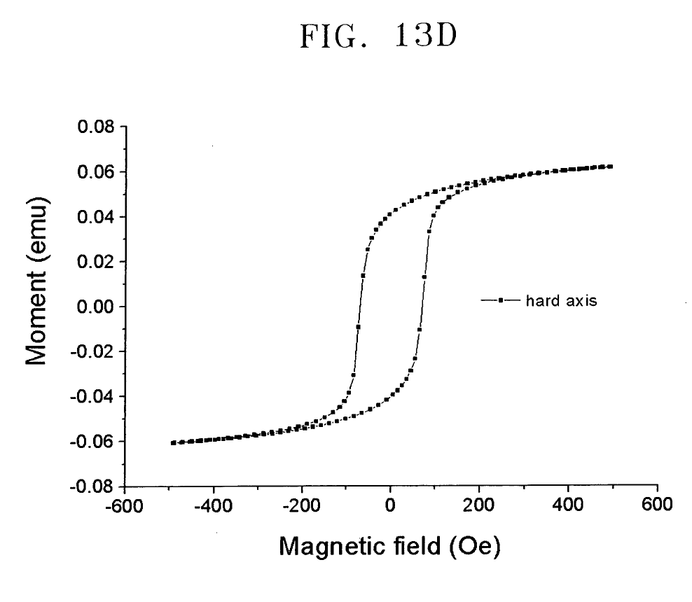

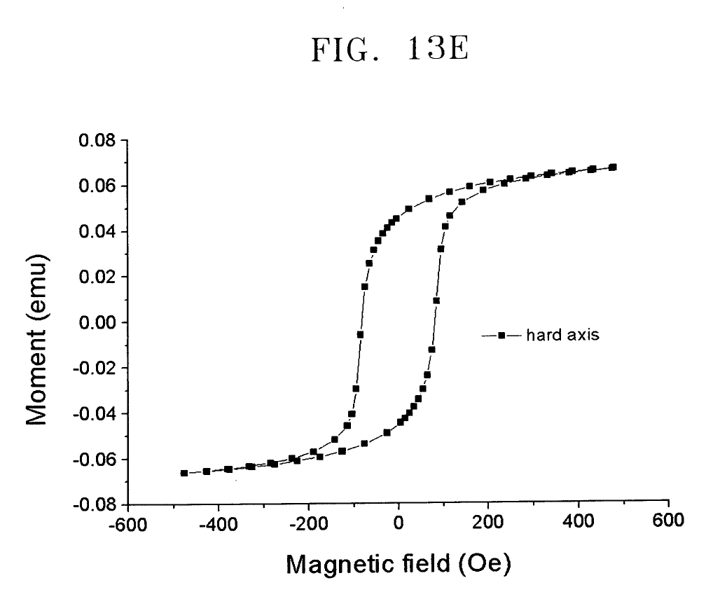

FIGS. 12A through 12E and FIGS. 13A through 13E are graphs of B-H properties at the respective temperatures. Particularly, FIGS. 12A through 12E are graphs of magnetic field-magnetic moment properties of the microinductor along a magnetization easy axis, and FIGS. 13A through 13E are graphs of magnetic field-moment properties of the microinductor along a magnetization hard axis.

FIGS. 12A and 13A show the deposited status as it was, FIGS. 12B and 13B show the heating at 300° C., FIGS. 12C and 13C show the heating at 400° C., FIGS. 12D and 13D show the heating at 500° C., and FIGS. 12E and 13E show the heating at 600° C. Referring to FIGS. 12A through 12E and 13A through 13E, the original magnetic film has the extremely high soft magnetism which is enhanced after heated at 300° C., whereas the coercivity is reduced. This is because the stress is reduced by the structural relaxation processes. However, as the heating temperature increases, the magnetic film is hardened and the coercivity increases, and the thin film gains isotropy.

Based on the experiment results as above, the microinductor can be applied to products of various applications by variously combining the size, the structure, and the shape of the respective components of the microinductor.

As set forth above, the present invention fabricates the magnetic core of the microinductor using FeCuNbCrSiB. Accordingly, the microinductor of the high operation characteristics can be fabricated in the miniature size with ultra lightness. Also, using the MEMS process, the components of the microstructural microinductor can be formed at the accurate positions and the compatibility with the existing semiconductor fabrication process can be achieved.

The foregoing embodiments are merely exemplary and are not to be construed as limiting the present invention. The present teaching can be readily applied to other types of apparatuses. Also, the description of the exemplary embodiments of the present invention is intended to be illustrative only, and not to limit the scope of the claims, as many alternatives, modifications, and variations will be apparent to those skilled in the art. Therefore, the scope of the present invention should be defined by the appended claims and their equivalents.

What is claimed is:

1. A microinductor comprising:
a magnetic core which is formed of FeCuNbCrSiB; and
a coil which winds around the magnetic core.

2. The microinductor of claim 1, further comprising:
an insulator which insulates the magnetic core.

3. The microinductor of claim 2, wherein the insulator is aluminum oxide.

4. The microinductor of claim 2, wherein the insulator is polyimide.

5. The microinductor of claim 1, further comprising:
a substrate which supports the magnetic core and the coil; and
a plurality of pads which are located on the substrate and connected to the coil.

6. The microinductor of claim 5, wherein the coil comprises:
a lower coil pattern which interposes between the substrate and the magnetic core;
an upper coil pattern which is located on the magnetic core; and
a via which connects the lower coil pattern to the upper coil pattern.

7. The microinductor of claim 5, wherein the magnetic core is a closed magnetic circuit which has two sides facing each other on the substrate.

8. The microinductor of claim 7, wherein the coil comprises:
a first coil which winds around a first side of the two sides of the magnetic core; and
a second coil which winds around a second side of the two sides of the magnetic core, the second coil connected to the first coil at one end.

9. The microinductor of claim 8, wherein one end of the first coil is connected to a first pad of the plurality of the pads, the other end of the first coil is connected to the one end of the second coil, and the other end of the second coil is connected to a second pad of the plurality of the pads.

10. The microinductor of claim 1, wherein a width of each winding of the coil is 20˜40 μm, a thickness of each winding is 5˜20 μm, and an interval between the windings is 20˜40 μm.

11. The microinductor of claim 10, wherein the magnetic core is a thin film type of thickness 2˜6 μm.

12. A fabrication method of a microinductor which comprises a magnetic core and a coil winding around the magnetic core, the method comprising:
forming a lower coil pattern on a substrate;
fabricating a magnetic core formed of FeCuNbCrSiB, in a pattern on the substrate where the lower coil pattern is formed;
forming a via pattern connected to the lower coil pattern; and
fabricating a coil to wind around the magnetic core by depositing an upper coil pattern being connected to the via pattern.

13. The fabrication method of claim 12, wherein the forming the lower coil pattern comprises:
forming a seed layer on a surface of the substrate and forming an alignment mark on at least one surface of the substrate; and
forming the lower coil pattern by plating along the seed layer, and
the fabricating the magnetic core, the forming the via pattern and the fabricating the coil are performed at a corresponding position based on the alignment mark.

14. The fabrication method of claim 12, wherein for the fabricating the magnetic core, the magnetic core is fabricated at a position apart from the lower coil by a distance, and the magnetic core is a closed magnetic circuit which has two sides facing each other.

15. The fabrication method of claim 12, wherein the fabricating the magnetic core comprises:
depositing a FeCuNbCrSiB film on the substrate where the lower coil pattern is formed, by sputtering using a FeCuNbCrSiB sample; and
fabricating the magnetic core by patterning the FeCuNbCrSiB film.

16. The fabrication Method of claim 12, wherein the forming the via pattern comprises:
forming a pad together with the via pattern.

17. The fabrication method of claim 12, further comprising:
annealing the microinductor in a vacuum furnace at a temperature while a magnetic field is applied.

18. The fabrication method of claim 15, wherein the sputtering process is conducted in a sputtering chamber in which the substrate having the lower coil pattern and the FeCuNbCrSiB sample are placed, under the following condition:
gas in sputtering chamber: argon
pressure in sputtering chamber: 4.2 Pa
sputtering time: 1˜2 h
sputtering power: 600 W
flow rate: 13 SCCM
magnitude of magnetic field: 16 kA/m
direction of magnetic field: parallel with the substrate surface.
